(19) United States
(12) Patent Application Publication
(10) Pub. No.: US 2023/0367764 A1
(43) Pub. Date: Nov. 16, 2023

(54) PARTIAL EXECUTION OF TRANSACTIONS IN PRIVATE DISTRIBUTED LEDGER NETWORKS

(71) Applicant: Telefonaktiebolaget LM Ericsson (publ), Stockholm (SE)

(72) Inventors: Remi ROBERT, Solna (SE); Mario MIKULAJ, Zagreb (HR)

(73) Assignee: Telefonaktiebolaget LM Ericsson (publ), Stockholm (SE)

(21) Appl. No.: 18/044,980

(22) PCT Filed: Sep. 11, 2020
(86) PCT No.: PCT/EP2020/075572

§ 371 Date: Mar. 10, 2023

(51) Int. Cl. G06F 16/23

(52) U.S. Cl. CPC G06F 16/2379

(57) ABSTRACT

A method for partial execution of a transaction in a distributed ledger (DL) network. —Execution of a transaction is requested. —First results of a first execution of the transaction and subroutine information for the transaction are received. An execution plan for executing one or more subroutines of the transaction is determined based on the subroutine information. Execution of the transaction by a second DL node of a second participant is requested. —Second results of a second execution of the transaction at the second DL node are received; and validation of the transaction is performed based on bundled results that include the first results and the second results.

### TECHNICAL FIELD

The present disclosure relates to the field of distributed ledger technology networks; and more specifically, to enabling partial execution of transactions in private distributed ledger networks.

### BACKGROUND

Distributed ledger technology (DL) networks are platforms used for building, running, and deploying a decentralized, distributed digital ledger. In a DL network a digital ledger permanently records digital records of transactions that occur between two participants. The records cannot be altered retroactively without the alteration of all subsequent transactions in the digital ledger and without consensus from multiple nodes in the DL technology network. Recordation of transactions in the digital ledger allows the participants to verify and audit transactions inexpensively and securely. A digital ledger is maintained without a central authority or implementation. In a DL technology network the data can be spread across multiple organizations, potentially in different countries, under different legislations, with different level of technical expertise.

DL networks may be public or private. Public DL networks are available to anyone who wants to join and use the network. In this type of DL network, anyone is allowed to read, write, or join the public DL network. In public DL networks, anyone, anywhere, can use the DL network to input transactions and data. In contrast, while private DL networks can be similar to public DL networks in certain aspects, they have access controls that restrict those that can join the network. Private DL networks have one or multiple entities that control the network.

In private DL networks consensus may be achieved when not all participants are involved in a transaction. Several features have been developed to allow to expose data to only a subset of the participants in the DL networks. For example, it is possible to disclose a private transaction to only some of the participants in the network. The disclosure of the private transaction to some of the participants can be achieved as follows: instead of broadcasting the transaction to all participants, the transaction is only sent to a subset of the participants that will be tasked with executing the transaction. Moreover, the transaction payload is not stored in the digital ledger, instead only an identifier of the transaction is recorded in the digital ledger, and the actual payload of the transaction is maintained by a transaction manager for each participant that is authorized to access the transaction. The identifier can be used to authenticate the payload of the transaction. Thus, each DL node in the DL network maintains a digital ledger and a database: the digital ledger stores the public state of the DL network (that is shared by all the DL nodes in the DL network) and the database contains the state of the DL network that originates from private transactions that the DL node was granted access to.

In some scenarios, multiple participants are allowed to access, process, and store private data in the DL network. In these scenarios, a transaction may include several objects, where each object can be accessed/executed by different participants. Thus, the execution of a transaction may require the concurrent modification of multiple objects by participants that have different access rights over the data altered within a single transaction. In this case, no participant is able to modify all of the objects of the transaction, and thus no participant is able to fully execute the entire transaction. Further, some systems may require that all data in a transaction be accessible/executable by the same participants, however, this is a very stringent requirements on smart contracts developers and makes for a very cumbersome logic when an object in a transaction is dependent on another one that has distinct owners. With existing solutions, implementing this requires splitting the state of the object into a public and private parts.

### SUMMARY

The embodiments described herein present a solution for enabling partial execution of transactions in a distributed ledger network. The solution integrates to the DL network the ability to partially execute subroutines of a smart contract for a transaction. The solution advantageously integrates the notion of partial execution of a transaction and validation of the transaction based on bundled results of the partial executions while improving the performance of the DL network and enabling a transaction to include and handle private data of multiple distinct participants. The solution enables reduction of the number of transactions needed for independent modification of independent objects, increases throughput, and decreases resource utilization. The solution further allows to write smart contracts with business rules dealing with dependencies between the states of two objects with distinct owners, which allows the support of use cases that were previously impossible to implement with smart contracts.

One general aspect includes a method in a client device of a distributed ledger (DL) network. The method also includes requesting execution of a transaction by a first DL node of a first participant from a plurality of participants in the DL network, where the first participant is trusted; receiving first results of a first execution of the transaction and subroutine information for the transaction, where the subroutine information includes a first subroutine associated with a first set of participants and a second subroutine associated with a second set of participants; obtaining an execution plan for executing the first subroutine and the second subroutine; based on the execution plan, requesting execution of the transaction by a second DL node of a second participant from the set of second participants; receiving second results of a second execution of the transaction at the second DL node; and performing validation of the transaction based on bundled results that include the first results and the second results.

One general aspect includes a client device in a distributed ledger network. The client device also includes one or more processors; and a computer readable storage medium storing instructions which when executed by the one or more processors cause the client device to perform operations including: requesting execution of a transaction by a first DL node of a first participant from a plurality of participants in the DL network, where the first participant is trusted; receiving first results of a first execution of the transaction and subroutine information for the transaction, where the subroutine information includes a first subroutine associated with a first set of participants and a second subroutine associated with a second set of participants; obtaining an execution plan for executing the first subroutine and the second subroutine; based on the execution plan, requesting execution of the transaction by a second DL node of a second participant from the second set of participants; receiving second results of a second execution of the transaction at the second DL node; and performing validation of the transaction based on bundled results that include the first results and the second results.

One general aspect includes a method in a DL node of a DL network. The method comprises receiving a request to execute a transaction that includes a first subroutine and a second subroutine; executing the first subroutine to obtain first results without executing the second subroutine; determining subroutine information for the transaction; and transmitting the first results and the subroutine information in response to the request to execute the transaction.

One general aspect includes a distributed ledger (DL) node (102A) in a DL network (100). The DL node comprising one or more processors; and a computer readable storage medium storing instructions which when executed by the one or more processors cause the client device to perform operations including: receiving a request to execute a transaction that includes a first subroutine and a second subroutine; executing the first subroutine to obtain first results without executing the second subroutine; determining subroutine information for the transaction; and transmitting the first results and the subroutine information in response to the request to execute the transaction.

### BRIEF DESCRIPTION OF THE DRAWINGS

The present disclosure may best be understood by referring to the following description and accompanying drawings that are used to illustrate embodiments of the present disclosure. In the drawings:

FIG. 1 illustrates a block diagram of an exemplary DL network that is operative to enable partial execution of transaction in a DL node, in accordance with some embodiments.

FIG. 2A illustrates a block diagrams of exemplary operations that can be performed in a DL network for partial execution of a transaction by a DL node, in accordance with some embodiments.

FIG. 2B illustrates a block diagrams of exemplary operations that can be performed in a DL network for partial execution of a transaction by a DL node, in accordance with some embodiments.

FIG. 3A illustrates a flow diagram of exemplary operations that can be performed in a DL network for partial execution of a transaction, in accordance with some embodiments.

FIG. 3B illustrates a flow diagram of exemplary operations that can be performed in a DL network for performing validation of a transaction based on bundled results, in accordance with some embodiments.

FIG. 3C illustrates a flow diagram of exemplary operations that can be performed in a DL network for performing validation of a transaction based on bundled results, in accordance with some embodiments.

FIG. 3D illustrates a flow diagram of exemplary operations that can be performed upon receipt of a request for execution of a transaction, in accordance with some embodiments.

FIG. 3E illustrates a flow diagram of exemplary operations that can be performed for partial execution of a transaction and determination of subroutine information for the transaction, in accordance with some embodiments.

FIG. 3F illustrates a flow diagram of exemplary operations that can be performed for validation of a transaction, in accordance with some embodiments.

FIG. 3G illustrates a flow diagram of exemplary operations that can be performed for validation of a transaction and validation of subroutines of the transaction, in accordance with some embodiments.

FIG. 4 illustrates a block diagram for a network device that can be used for implementing one or more of the DL nodes described herein, in accordance with some embodiments.

FIG. 5 illustrates a block diagram for network devices that can be used for implementing a DL node described herein, in accordance with some embodiments.

### DETAILED DESCRIPTION

The following description describes methods and apparatus for enabling partial execution of transactions in a DL network. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that the embodiments may be practiced without such specific details. In other instances, control structures, gate level circuits and full software instruction sequences have not been shown in detail in order not to obscure the embodiments. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to some embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The embodiments described herein address the shortcomings and disadvantages of existing DL network. The embodiments herein present systems and methods of a DL network that enable partial execution of transactions by DL nodes in a DL network. The solution proposed herein includes operations performed by a client of a DL network and DL nodes of the DL network. In some embodiments, a smart contract in the DL network includes a definition of the participants that are authorized to execute and/or endorse a subroutine of the smart contract. The definition of the participants can either be a static or a dynamic definition performed at runtime.

In some embodiments, prior to submitting a transaction to the DL network, a determination of the set of participants that are allowed to access one or more subroutines of a transaction in a DL network is performed. In some embodiments, the determination of the set of participants further includes the determination of the arguments that are to be transmitted to each of the participants for executing/endorsing one or more of the subroutines of the transaction. The transaction is constituted in one or more sub-routines for each of the determined participants. In some embodiments, at least two sub-subroutines are generated from the transaction, where each sub-routine is associated with one or more participants that are authorized to access it and corresponding parameters for its execution. Each participant then executes the subroutines of the transaction that are common to all, or for which they have access. The results of the execution by each participant are then consolidated and submitted to the distributed ledger. The validity of the overall transaction can be assessed by verifying that the overall contract received the needed endorsement and that each subroutine has received the endorsements that it needed.

Some embodiments described herein present a decomposition of a smart contract into subroutines which are associated with different participants in a DL network. The different participants perform the partial execution of the smart contract by executing the subroutine that they are respectively authorized to access and the validation of the proper execution of the overall transaction based on the bundle of partial execution results.

The embodiments described herein present several advantages when compared with existing DL networks. The embodiments herein enable the execution of multiple subroutines of a single transaction that can be accessed by distinct participants in the DL network. The embodiments herein enable the reduction in the number of transactions needed for independent modification of independent subroutines of a transaction. The embodiments improve the performance of the execution of a transaction as a side effect of the reduced number of transactions to process. The embodiments increase throughput and decrease resource utilization. The embodiments enable developers to write smart contracts with business rules dealing with dependencies between the states modified by two subroutines of a smart contract with distinct owners.

Overview:

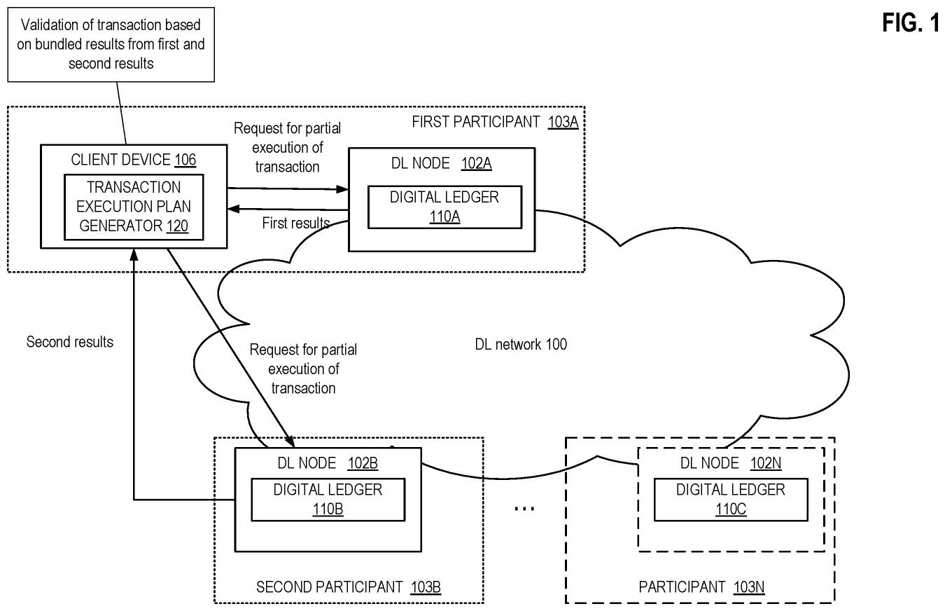

FIG. 1 illustrates a block diagram of an exemplary DL network that is operative to enable partial execution of transaction in a DL node, in accordance with some embodiments. In the following description some examples will be described for a particular type of DL networks, namely DL networks that support smart contracts. However, the embodiments described herein generally apply to other types of DL networks, which do not necessarily need to implement and support smart contracts.

The DL network 100 includes a set of participants 103A-N. Each participant is associated with one or more DL nodes and client devices. The various nodes and client devices communicate through a physical network (wired, wireless, or a combination of wired and wireless networking technology) that is not illustrated. The DL network 100 is a private distributed ledger that is operative to enable participants in the network to have access to private data while other participants in the network cannot access this private data. In some embodiments, the DL network 100 is operative to enable participants to have access to public data that all participants can view. In some embodiments, the DL network 100 is a blockchain network. In some embodiments, the DL nodes 102A-N, may be permissioned to join the DL network 100 via, for example, an access control list. In some embodiments, the access control list can be managed by smart contract.

A participant in the DL network 100 is an entity that can participate and contribute to transactions with other participants in the ledger. The participant can be a person, an organization, a program run on a processor, etc. The participant is associated with a node that is used to access the DL network 100. The node of the participant can be a DL node, e.g., DL node 102A or DL node 102N, or a client device, e.g., client device 106, that is not part of the DL network 100. In a non-limiting example, the DL network 100 includes multiple participants 103A-N. The first participant 103A owns and/or operate one or more DL nodes 102A. Optionally, the first participant can own and/or operate one or more other DL nodes. The first participant 103A further owns and/or operate one or more other types of nodes, e.g., client device 106 that enable users associated with the participant 103A to access the distributed ledger (DL) network 100. The second participant 103B owns and/or operate one or more DL nodes 102B. Optionally, the second participant can own and/or operate one or more other nodes (not illustrated) that enable users associated with the participant 103B to access the DL network 100. In some embodiments, the DL network 100 may further include additional participants and nodes, e.g., participant 103N. Participant 103N owns and/or operate one or more DL nodes 102N. The participant 103N can own and/or operate one or more other nodes (not illustrated) that enable users associated with the participant 103N to access the DL network 100. While the DL network 100 is illustrated as including three participants, each associated with a given number of DL nodes and/or client devices, this is intended to be exemplary only, and different numbers of participants can be part of the DL network 100 with different numbers of DL nodes or client devices.

A client device 106 is a node that allows to interface with the DL network 100 through a DL node. It can be used, for instance, to build and submit a transaction request to one or more nodes of the DL network 100. In some embodiments, the client device 106 is operative to determine for subroutines of a transaction their associated recipients. Further, the client device 106 is operative to determine, based on the recipients and/or additional metadata for the subroutines of a transaction, a transaction execution plan for partial execution of the transaction by two or more DL nodes in the DL network 100. In some embodiments, the client device is further operative to bundle the result of multiple partial executions of a transaction and record the transaction in the DL network 100. While the embodiments herein will be described with a client device performing the determination of the recipients for the subroutines and the determination of the transaction execution plan, in other embodiments, another node may perform these operations. For example, the DL node 102A may be operative to perform these operations upon receipt of a request from the client device 106. In other examples, another node that is separate from the DL node 102A and from the client device 106 can be operative to perform these operations.

A DL node is a node that is operative to perform some, or all operations related to updating and maintaining the digital ledger. For example, a DL node can be a full node that stores the entire digital ledger. Alternatively, the DL node can be a light node, which may include only a partial list of the digital ledger. The DL node may further be operative to receive transaction requests from client devices, evaluate the transactions, and validates them to be added to the digital ledger based on a consensus algorithm (such as Proof of Work (PoW), Proof of Stake (PoS), or other). Thus, the DL node is operative to synchronize the state of the digital ledger, as well as receive request from users to alter the state (receive, evaluate, and validate transactions). Additionally, the DL node is also operative to partially execute a transaction as discussed in further detail with respect to some embodiments herein. A partial execution of a transaction includes the partial execution of the code of the transaction, i.e., execution of a subset of subroutines that form the code of the transaction. In some embodiments, in addition to partially executing a transaction a DL node is operative to determine subroutine information for the subroutines of the transaction. In some embodiments, the output of the partial execution of a transaction includes the subroutine information and the result of the execution of each subroutine that the DL node is authorized to access. The result of the execution of a subroutine may include one or more modifications to the state of the digital ledger 110. The result of the execution may further include one or more events. In some embodiments, the DL node is operative to validate a transaction based on a bundle of partial execution results. In some embodiments, a DL node of a first participant may be operative to fully execute a transaction while being operative to partially execute another transaction. Further, a DL node of a first participant may be operative to partially execute a transaction by executing a first subroutine of a transaction and not being authorized to execute a second subroutine of the same transaction. Another DL node of another participant may be operative to partially execute the same transaction by executing the second subroutine and not being authorized to execute the first subroutine.

A DL node includes a digital ledger. The DL node is operative to store private data and public data. The private data can belong to the participant that owns the DL node or data that belongs to one or more participants different from the participant that owns the DL node. The DL node may include additional elements that are not illustrated. For example, a DL node may include a DL network state(s), and a transaction manager.

The digital ledger 110A is a list of transactions that occurred on the DL network 100. Once transactions are written to the digital ledger 110A, they cannot be modified; the record of transactions (i.e., the digital ledger 110A) is immutable. While the DL nodes 102A-B are illustrated as including digital ledgers 110A, 110B, typically each one of the DL nodes 102A-B includes an identical copy of the digital ledger. The digital ledger stored on each one of the DL nodes 102A-B includes the same data. In some embodiments, some of the nodes may be light DL nodes including a subset of the entire digital ledger for the DL network 100. Thus, one or more of the DL nodes may include a copy of all or a portion of the digital ledger 110A.

The transactions stored in the digital ledger 110A may include private transactions and public transactions. A public transaction is a transaction that is available to be viewed by all of the participants of the DL network 100. In contrast, a private transaction is only available to be viewed by some of the participants but not by all of the participants of the DL network 100. For private transactions, an identifier of each private transaction is stored in the digital ledger 110A instead of the payload of the transaction. The payload of a transaction contains the actual details about the transaction and is not stored in the digital ledger. This ensures that the payload of any private transaction is not accessible to participants that are not recipients of the transactions. In one example, the identifier of the transaction can be a hash of the payload of the transactions. In the description herein, a recipient of the transaction refers to a participant of the DL network that is allowed to have access/view a private transaction. A private transaction can have one or more recipients. For public transactions, the digital ledger 110A stores the payload of the transactions consequently allowing any participant of the DL network 100 to access/view the payload of these public transactions by accessing the digital ledger 110A. Each transaction includes data (e.g., input and output of the transaction).

In one example, the digital ledger 110A can be a blockchain. In this example, transactions are collected inside blocks that are appended to the blockchain. In addition to the transactions, each block may include additional fields (e.g., a block header). In other examples, the digital ledger 110A can be another structure different from the blockchain that is operative to store private and public transactions.

The DL network supports smart contracts. In some embodiments, the smart contracts are stored as part of the digital ledger 110A. In other embodiments, the smart contracts are stored independently of the digital ledger 110A. A smart contract is computer code that implements a computer protocol intended to digitally facilitate, verify, or enforce the negotiation or performance of a contract. A smart contract is usually written in a human readable language that is then compiled to a machine language before execution. Consensus is achieved, using the ledger protocols, regarding the definition of each smart contract. A smart contract allows the execution of transactions between two parties without a third party. Once executed, the transactions of a smart contract are stored in the digital ledger 110A and are trackable and irreversible.

In some embodiments, a smart contract includes a set of one or more subroutines. A subroutine is a sequence of program instructions that performs a specific task, packaged as a unit. This unit can then be used in programs wherever that particular task is to be performed. A subroutine may be called a procedure, a function, a routine, a method, a subprogram, or more generally a callable unit. A request to execute a transaction of a smart contract is a request to execute the one or more subroutines that form the smart contract of the transaction. In the embodiments described herein a subroutine is associated with an identifier, a set of arguments, a set of recipients, and endorsement rules.

The identifier of a subroutine identifies the subroutine in the DL network. In some embodiments, the identifier identifies the subroutine within the transaction. For example, the identifier may be an index that is incremented by one for each new subroutine encountered during execution of a transaction. In this example, the identifier of a subroutine is determined based on order of execution of the subroutine with respect to other subroutines in the transaction.

The set of recipients identifies the participants that are authorized to execute the subroutine. The recipients are authorized to access the private data that are handled by the subroutine (e.g., the inputs and/or outputs of the subroutine). In some embodiments, the set of recipients may identify all of the participants of the DL network 100 as being allowed to access/execute the subroutine. In some embodiments, the set of recipients identifies a subset of all of the participants (where the subset is strictly less than all of the participants in the DL network) as being allowed to access/execute the subroutine. In non-limiting example, if the set of recipients of a subroutine is empty, it is an indication that the subroutine is common to all DL nodes of the DL network 100 and that it can be executed by all of the DL nodes. In some embodiments, the execution of this subroutine may be needed to support the execution of other subroutines and therefore access to the subroutine is provided to all participants in the network. If the set of recipients of a subroutine is not empty, it contains the list of the participants that can execute this subroutine. In some embodiments, two different subroutines may have two distinct sets of recipients that are authorized to access them. In some embodiments, two different subroutines of the smart contract may have in common one or more participants authorized to access them.

The subroutine is further associated with an endorsement rule. The endorsement rule includes logic governing how many executions results are needed for this subroutine and which participants need to execute this subroutine for the subroutine to be considered valid. The embodiments herein enable the definition of the endorsement rules at the granularity of the subroutine instead of the granularity of the smart contract as it is the case in prior DL network.

The subroutine is further associated with a subset of arguments. The subset of arguments are parameters from the transactions that are used in the subroutine. In some embodiments, the arguments of the subroutine are a subset of the argument of the transaction that calls the subroutine, where the subset can be all of the arguments or a strict subset (strictly less than all of the arguments) of the transaction. In some embodiments, two different subroutines of a smart contract may have two distinct sets of arguments or share some of the arguments.

In some embodiments, one or a combination of the identifier, the set of recipients, the endorsement rule, and the subset of arguments of subroutine can be defined statically (at definition of the smart contract) or dynamically (during execution of a transaction of a smart contract). Further, a subroutine (e.g., a loop) may have a first set of endorsement rules and recipients that are associated with it during a first iteration and a different set of endorsement rules and/or different recipients that are associated with it during another iteration (e.g., a second iteration of the loop).

In a non-limiting example, the DL network 100 may be used to implement a decentralized service marketplace. In this exemplary scenario, participants of the DL network include service providers and customers of the service providers. A service provider offers one or more services to potential customers. A customer may select to subscribe to one or multiple ones of these services. The private data functionalities in the DL network 100 are leveraged to restrict the spread of the data on the relationship between a service provider and a customer to DL nodes that are owned by these two participants. The embodiments described herein enable the DL network 100 to allow execution of transactions that are accessible by different participants and which may be partially executed by these participants, while ensuring that the privacy of the data is satisfied. For example, the embodiments described herein allow to implement a service marketplace where two different relationships (e.g., a first service provider and customer relationship and a second service provider and customer relationship) to be modified in a single transaction. In such a configuration, the details of the relations between each of these service providers and the customer is still known only by the service provider and the customer. However, in the DL network, a smart contract is defined based on the services offered by the two service providers for that customer. In some embodiments, the smart contract can be defined such that if the subscription to one service is revoked, the subscription to any other service within that same smart contract is suspended as well.

Thus, the embodiments described herein enable new applications and uses of service marketplaces based on private DL networks that are advantageous when compared with existing DL networks. The embodiments allow for a partial execution of transactions by different participants in the DL network while maintaining privacy of the data in the DL network and validity of transaction execution.

Partial Execution(s) of a Transaction

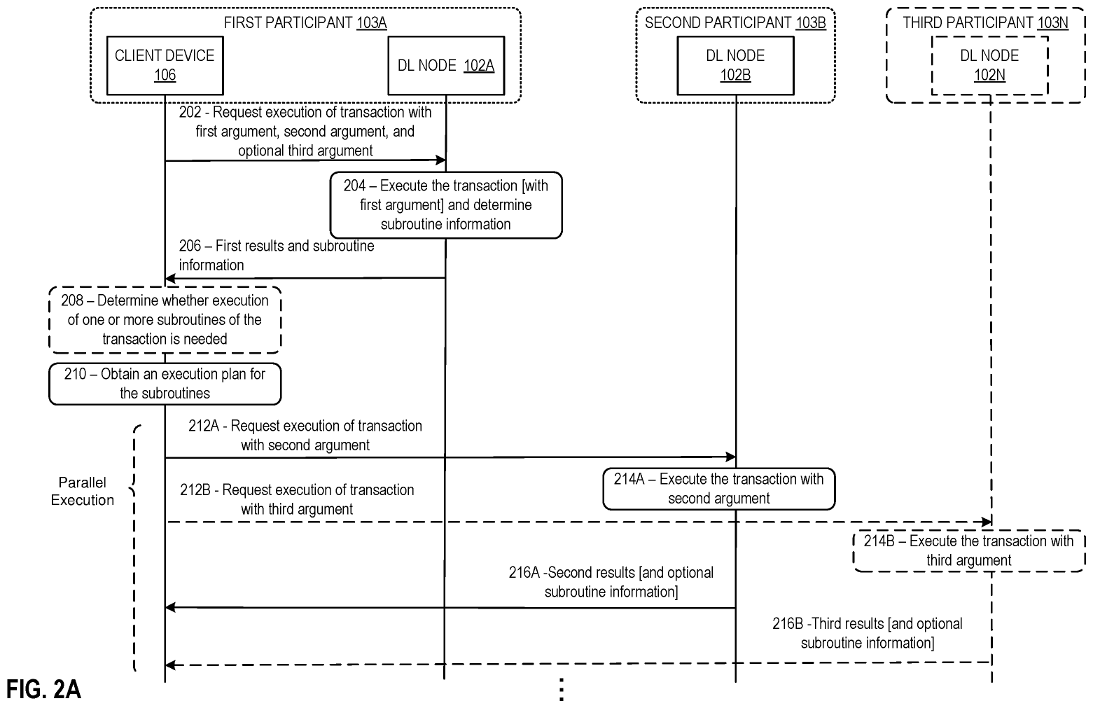

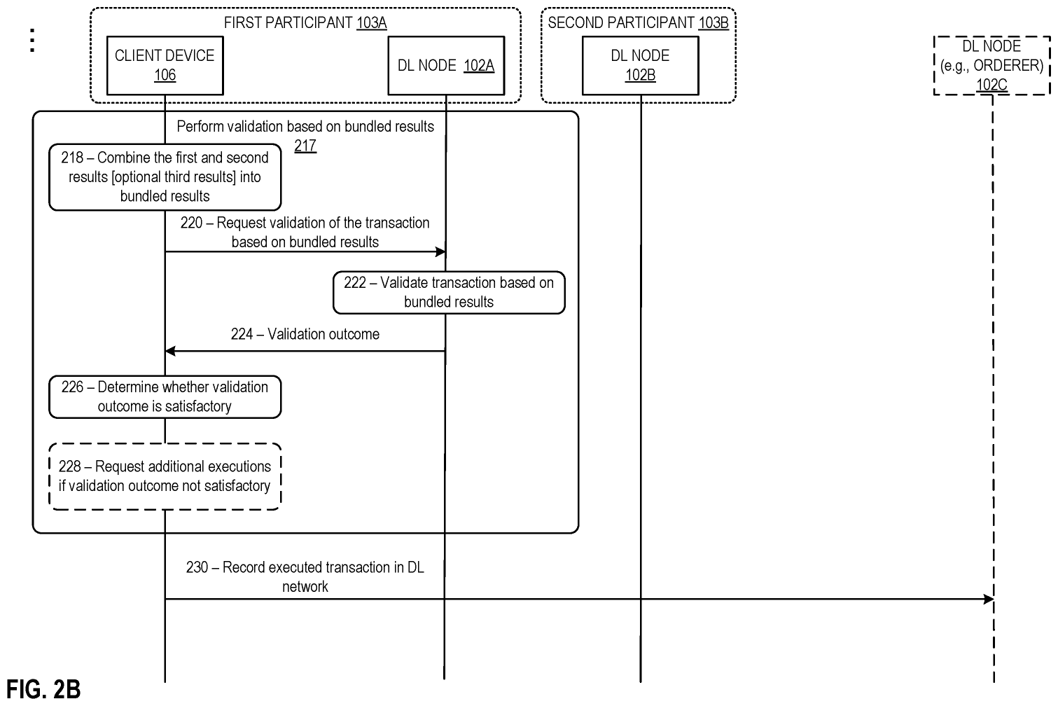

FIGS. 2A-B illustrate block diagrams of exemplary operations that can be performed in a DL network for partial execution of a transaction by a DL node, in accordance with some embodiments. The operations of FIGS. 2A-B will be described with reference to the components described with reference to FIG. 1. In the following description the operations of the embodiments herein will be described with respect to the client device 106, the DL node 102A of the first participant 103A and the DL node 102B of the second participant 103B. However, this is intended to be exemplary only and the same operations can be performed by multiple ones of the nodes of the DL network 100. While the embodiments herein are described with respect to a client device 106 that is not part of the DL network 100, in other embodiments, the client device 106 includes functionalities of a DL node and is part of the DL network 100. In these embodiments, some operations that will be described below as performed by DL node 102A are performed by client device 106.

While the embodiments herein are described with respect to a transaction of a smart contract, in other embodiments, the transaction is of a method of a smart contract (which may be only a sub part of the smart contract). Further, while the embodiments are described with respect to smart contracts, one of ordinary skill in the art would understand that similar operations can be performed in other types of DL networks where a transaction can be partitioned into subroutines. In some embodiments, a smart contract is partitioned into multiple subroutines, where subroutines are associated with different sets of participants. In some embodiments, two different subroutines are associated with two sets of participants where at least one participant that is included in a first set of participants is not included in the other set of participants. In some embodiments, different subroutines may have participants in common. When a subroutine is associated with a participant, it is an indication that the participant and their DL nodes are allowed/authorized to access and/or execute the subroutine. In some embodiments, the partition of a smart contract into subroutines and the determination of the associated participants for each subroutine are performed statically at the time that the smart contract is coded. Alternatively or additionally, the partition of the smart contract and the determination of the associated participants for the subroutines can be performed dynamically at runtime, when the smart contract is executed in the DL network 100.

At operation 202, the client device 106 requests execution of a transaction by a first DL node 102A of a first participant 103A from the participants 103A-N in the DL network 100. The first participant is trusted by the client device 106. For example, the client device 106 is owned/operated by the first participant 103A. In another example, the client device 106 is operated by a customer of the first participant 103A and trust relationship is established between the client device 106 and the DL node 102A of the first participant (e.g., through an authentication mechanism). Because of the trust relationship established between the client device 106 and DL node 102A, the DL node 102A is trusted with the handling of the input data without worrying about data privacy (the client device 106 and DL node 102A are in the same security domain). In some embodiments, the transaction includes zero or more arguments. The transaction may include a set of arguments including a first argument and a second argument. In some embodiments, the transaction may include more than two arguments, e.g., an additional optional third argument. In some embodiments, the request for the transaction includes a call to a smart contract with the arguments of the transaction. For example, the call can be a call for execution of a method from a smart contract with the first argument and a second argument. The smart contract may include one or more subroutines.

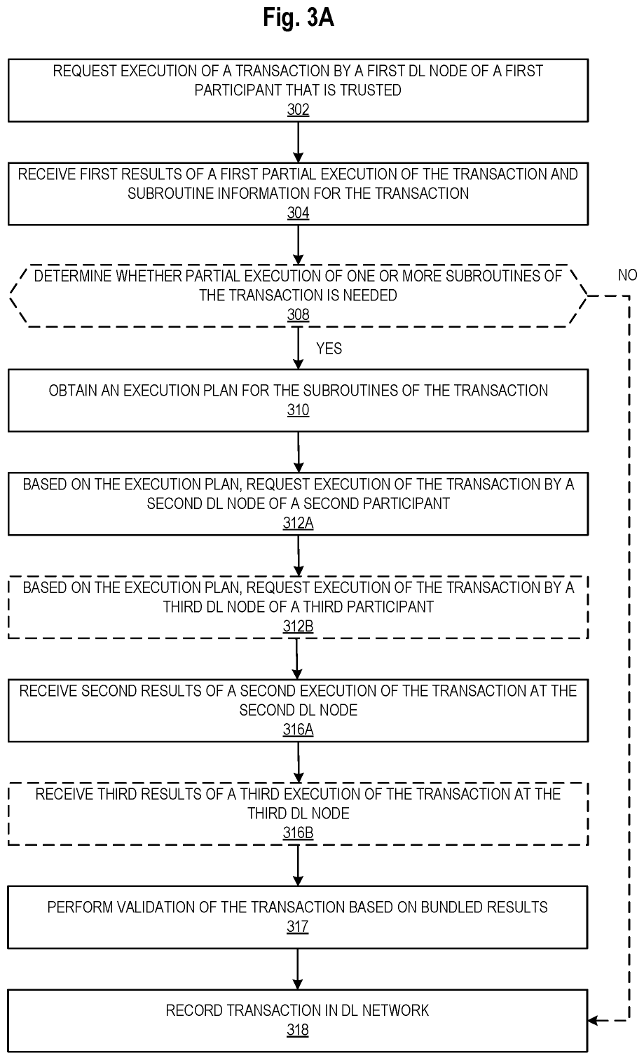

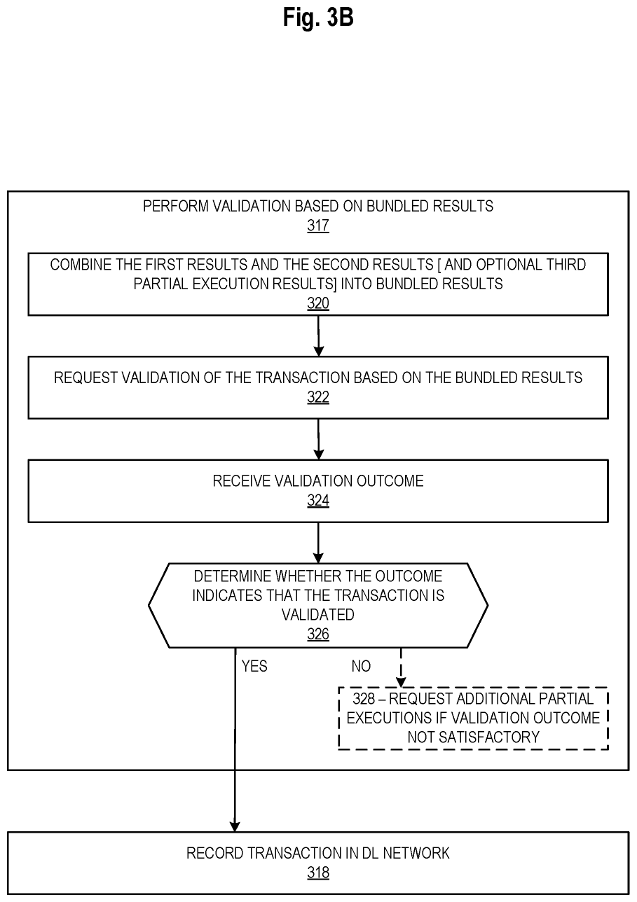

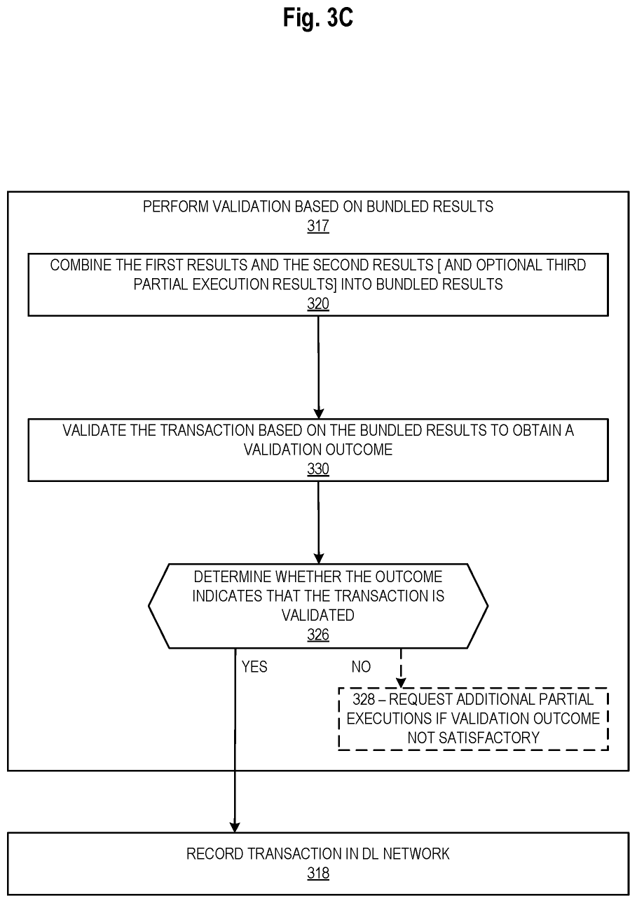

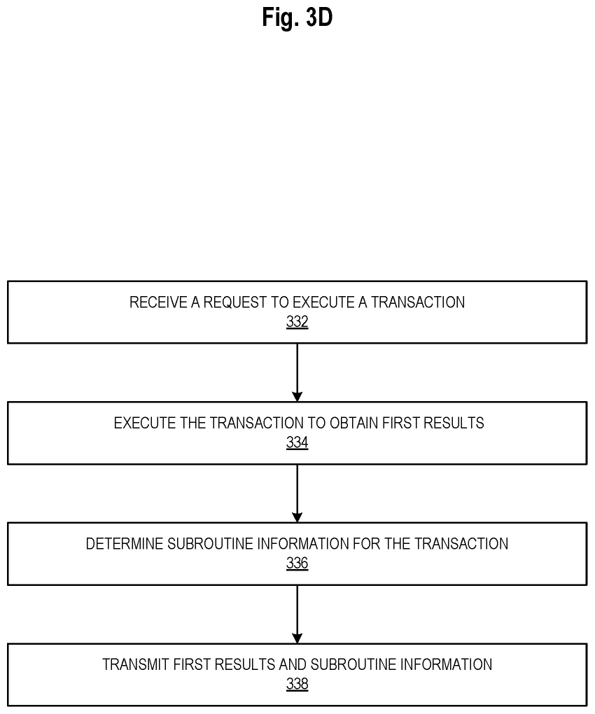

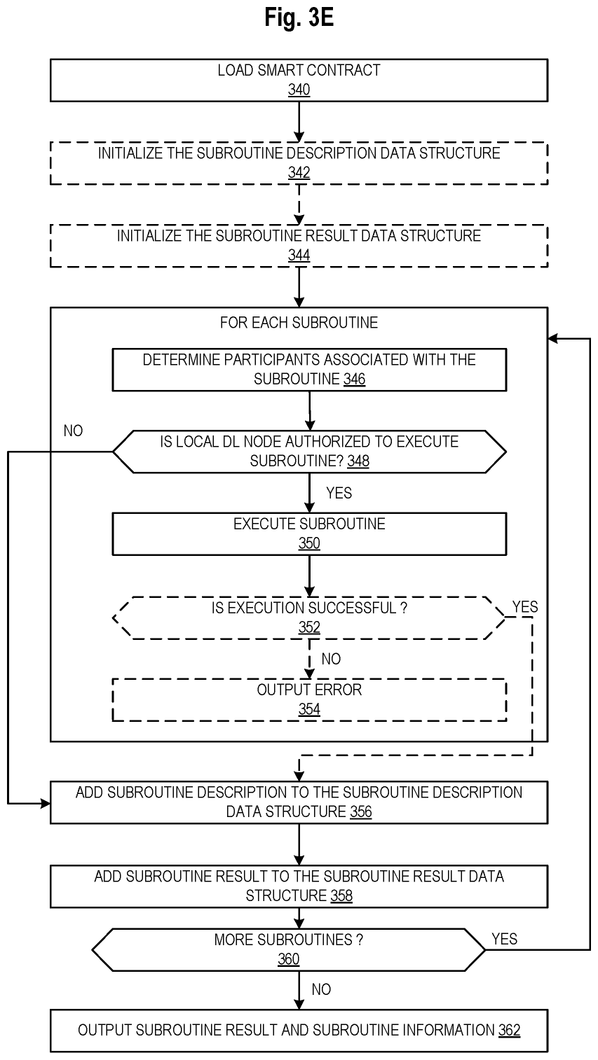

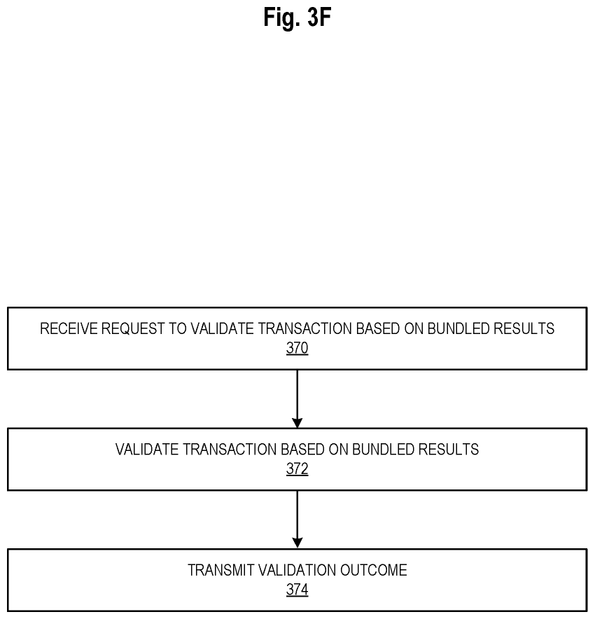

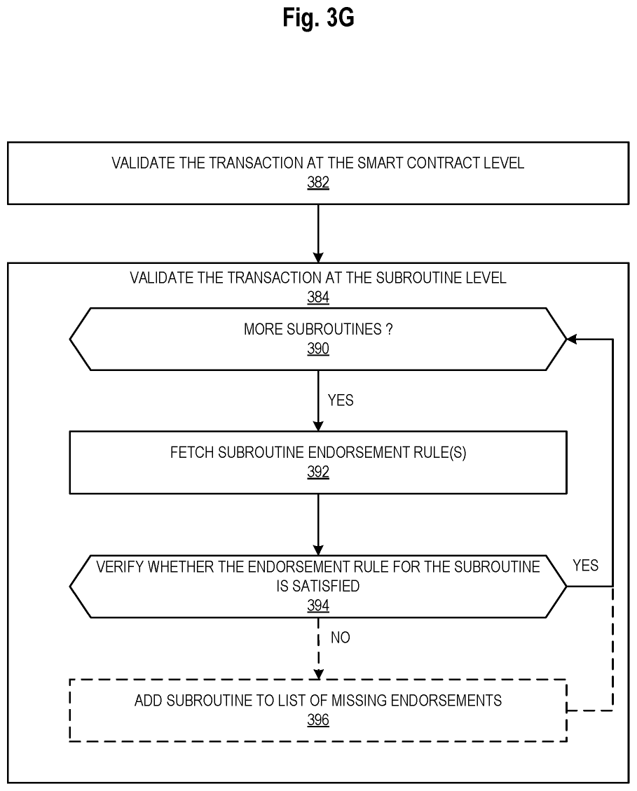

The DL node 102A receives the request for execution of the transaction. At operation 204, the DL node 102A executes the transaction and determines subroutine information for the transaction. The subroutine information includes one or more subroutines of a smart contract (or a method of the smart contract) that need to be executed for fully executing the transaction. In some embodiments, the subroutine information includes a first subroutine associated with a first set of participants and a second subroutine associated with a second set of participants. The execution of the transaction may include the execution of one or more subroutines of the transaction that the DL node 102A is authorized to access/execute. The execution of the transaction may be a partial execution where some but not all of the subroutines that form the transaction are executed by the DL node 102A. For example, the execution of the transaction may include execution of the first subroutine with the first argument without execution of the second subroutine as the DL node is determined to be authorized to execute the first subroutine but not the second subroutine. Alternatively or additionally, the execution of the first subroutine but not the second subroutine may be due to the DL node 102A being authorized to access and use the first argument but not the second argument. For example, the second argument may be private data that is not accessible to the DL node 102A. While herein DL node 102A is described as being authorized and/or having access to a subroutine or data handled by the subroutine, one of ordinary skill in the art would understand that this authorization can be given to the owner/operator of the DL node 102A, the participant 103A. Therefore, a DL node 102A may be authorized to access data or subroutines as a result of the participant 103A having that authorization. In some embodiments, first results are obtained from the execution of the transaction by DL node 102A (e.g., by execution of the first subroutine with the first argument). In some embodiments, execution of the transaction can be performed as described in further detail with respect to FIG. 3E.

At operation 206, the DL node 102A transmits the first results and the subroutine information to the client device 106. In some embodiments, the subroutine information and first results are signed by the DL node 102A.

The client device 106 receives first results of a first execution of the transaction and subroutine information for the transaction. At operation 208, the client device 106 determines whether partial execution of one or more subroutines of the transaction is needed. Determining whether the partial execution of subroutines is needed may be performed upon determining that the result received from the DL node 102A are partial results and do not represent the full execution of all subroutines of the transaction. In some embodiments, determining that the partial execution of subroutines is needed is performed upon receipt of the subroutine information that identifies multiple distinct participants as authorized to execute different subroutines. In some embodiments, this operation is optional and may not be performed. If it is determined that no partial execution of the transaction is needed (i.e., the transaction has been fully executed), the flow of operations moves to operation 230, at which the client device 106 records the transaction in the DL network 100. Recording the transaction in the DL network 100 includes storing the transaction in the digital ledger of the DL network 100. Alternatively, if it is determined that partial execution of subroutines is needed the flow of operations moves to operation 210.

At operation 210, the client device 106 obtains an execution plan for the subroutines of the transaction. In some embodiments, the client device 106 is operative to perform the determination of the execution plan. In some embodiments, the client device 106 is operative to communicate with another node (another electronic device that is communicatively coupled with the client device) that is to determine the execution plan. In this embodiment, the client device 106 is operative to transmit subroutine information (and optionally the first results) to the node and receive the execution plan from the node. The determination of the execution plan is performed at the node.

In some embodiments, determining an execution plan for the subroutines of the transaction includes determining one or more participants and/or DL nodes of participants that can execute the transaction (at least partially) for enabling full execution of the transaction. The participants can be indicated in the subroutine information, where each subroutine is associated with one or more participants that are authorized to execute/access the subroutine. In some embodiments, the determination of the execution plan can further be performed based on external knowledge of the state of the various DL nodes/participants in the DL network. For example, the execution plan may include the first participant for first subroutine and second participant for second subroutine. In some embodiments, the execution plan further identifies for each subroutine the argument(s) that the subroutine needs for execution. For example, the execution plan may identify a first argument for a first subroutine and a second argument for a second subroutine. In some embodiments, the determination of the execution plan can further be performed based on the endorsement rule(s) defined for one or more of the subroutines. For example, an endorsement rule for a first subroutine may include that the subroutine is to be executed/endorsed by at least two participants. In this example, the execution plan includes an indication that the transaction is to be executed by the first participant and an indication that transaction is to be execution by a second participant.

At operation 212A, the client device 106 requests execution of the transaction by a second DL node of a second participant based on the execution plan. For example, upon determining that the second participant is authorized to execute the second subroutine, the client device requests execution of the transaction and includes the second argument for the second subroutine. In some embodiments, the request for execution of the transaction sent to the second DL node does not includes any argument that is not needed by the second subroutine. For example, the request does not include the first argument, which is used for the first subroutine. In some embodiments, the client device 106 transmits to the second DL node only the arguments that the second participant is authorized to access. In other embodiments, the client device 106 may transmit additional arguments in the request, which may or may not be used by the DL node 102B during partial execution of the transaction.

In some embodiments, the transaction may include additional subroutines, e.g., third subroutine. In these embodiments, the flow of operations may further include operation 212B. At operation 212B, the client device 106 requests execution of the transaction by a third DL node of a third participant based on the execution plan. For example, upon determining that the third participant is authorized to execute the third subroutine, the client device 106 requests execution of the transaction and includes the third argument for the third subroutine. In some embodiments, the request for execution of the transaction sent to the third DL node does not includes any argument that is not needed by the third subroutine. In some embodiments, the third subroutine may use one or more arguments that are common to one or more other subroutines. For example, the third subroutine may further need the second argument to be executed. In this example, the client device 106 may transmit to the third DL node the request for execution of the transaction including the second argument and the third argument.

In some embodiments, the execution plan indicates that the same subroutine, e.g., second subroutine needs to be executed by more than one participant for the transaction to be considered executed and valid. In these embodiments, operation 212B may include transmitting the transaction with the second argument to another participant, third participant, to execute the second subroutine.

The DL node 102B receives the request for execution of the transaction. At operation 214A, The DL node 102B partially executes the transaction to obtain second results. The partial execution of the transaction may include the execution of one or more subroutines of the transaction that the DL node 102B is authorized to access/execute. For example, the partial execution of the transaction may include execution of the second subroutine with the second argument without execution of the first subroutine as the DL node is determined to be authorized to execute the second subroutine but not the first subroutine. Alternatively or additionally, the execution of the second subroutine but not the first subroutine may be due to the DL node 102B being authorized to access and use the second argument but not the first argument. For example, the first argument may be private data that is not accessible to the DL node 102B. While herein DL node 102B is described as being authorized and/or having access to a subroutine or data, one of ordinary skill in the art would understand that this authorization can be given to the owner/operator of the DL node 102B, the participant 103B. Therefore, a DL node 102B may be authorized to access data or subroutines as a result of the participant 103B having that authorization. In some embodiments, second results are obtained from the partial execution of the transaction by DL node 102B (e.g., by execution of the second subroutine with the second argument). In some embodiments, partial execution of the transaction can be performed as described in further detail with respect to FIG. 3E.

In some embodiments, when additional subroutines are identified, the DL node 102N may also partially execute the transaction with a third argument at operation 214B. The partial execution of the transaction may include the execution of one or more subroutines of the transaction that the DL node 102N is authorized to access/execute. For example, the partial execution of the transaction may include execution of the third subroutine with the third argument without execution of the first or the second subroutines as the DL node is determined to be authorized to execute the third subroutine but not the first subroutine or the second subroutine. Alternatively or additionally, the execution of the third subroutine may be due to the DL node 102N being authorized to access and use the third argument but not the first or the second arguments. In some embodiments, third results are obtained from the partial execution of the transaction by DL node 102N (e.g., by execution of the third subroutine with the third argument). In some embodiments, partial execution of the transaction can be performed as described in further detail with respect to FIG. 3E.

At operation 216A, the DL node 102A transmits the second results of the second partial execution of the transaction to the client device 106. The client device 106 receives second results of a second partial execution of the transaction at the second DL node. In some embodiments, the client device 106 further receives the subroutine information as determined by the DL node 102B following the partial execution of the transaction. In some embodiments, the subroutine information is the same information as the one received from the DL node 102A. In some embodiments, the subroutine information is not received as it is previously received from the DL node 102A.

When the execution plan includes more than one subroutine to be executed, the flow of operations may include operations 216B. At operation 216B, the DL node 102N transmits third results of the partial execution of the transaction (e.g., execution of the third subroutine with the third argument). The client device 106 receives the third results of a third partial execution of the transaction at the third DL node 102N. In some embodiments, the third results are obtained following the partial execution of the transaction by DL node 102N. In some embodiments, the client device 106 further receives the subroutine information as determined by the DL node 102N following the partial execution of the transaction. In some embodiments, the subroutine information is the same information as the one received from the DL node 102A or the DL node 102B. In some embodiments, the subroutine information is not received as it is previously received from the DL node 102A. The partial executions can be performed in parallel improving the performance of the system for execution of the transaction.

At operation 217, the client device 106 performs validation of the transaction based on bundled results that include the first results and the second results. At operation 218, the client device 106 combines results obtained from partial executions at multiple DL nodes of different participants to obtain bundled results for the transaction. For example, the client device 106 combines the first and the second results to obtain the bundled results. The client device 106 requests, at operation 220, validation of the transaction based on bundled results. In some embodiments, the request for validation of the transaction is transmitted to the DL node 102A that is trusted by the client device 106. The DL node 102A validates the transaction based on the bundled results at operation 222. In some embodiments, the validation can be performed as described with respect to FIG. 3G. The DL node 102A transmits a validation outcome to the client device 106 at operation 224. The validation outcome may include an indication that the execution of the transaction is valid. Alternatively, the validation outcome may include an indication that the execution of the transaction is not valid. In this case, the validation outcome may include the identification of one or more executions that need to be performed for validating the execution of the transaction.

At operation 226, the client device 106 determines whether the validation outcome is satisfactory. Upon determining that the transaction is not validated, the client device 106 may at operation 228, request additional partial executions of the transaction. When one or more executions are identified as being needed for completing the execution and validation of the transaction, the execution plan may be updated to include the additional executions. For example, the execution plan may be updated to include one or more additional participant(s) that are to execute one or more additional subroutine(s) of the transaction with additional argument(s). The client device 106 is operative to request execution of the additional subroutine(s) from the additional participants. Upon determining that the transaction is validated, the flow of operations moves to operation 230. At operation 230, the client device 106 records the transaction in the DL network 100. In some embodiments, recording the transaction in the DL network 100 includes transmitting the transaction with the bundled results to an orderer node in the DL network 100. The orderer node is operative to include the transaction in a block or other data structure for inclusion in the digital ledger of the DL network 100. In some embodiments, recording the transaction in the DL network 100 may include transmitting the transaction with the bundled results to one or more of the DL nodes (e.g., DL node 102A-N) for performing a consensus algorithm and including the transaction in the digital ledger of the DL network. In some embodiments, recording the transaction may further cause one or more additional DL nodes to validate the transaction as per the operations of FIG. 3G.

Exemplary Operations

The operations in the flow diagram of FIG. 3A-G will be described with reference to the exemplary embodiments of FIG. 1 and FIGS. 2A-B. However, it should be understood that the operations of the flow diagrams can be performed by embodiments of the invention other than those discussed with reference to FIG. 1 and FIGS. 2A-B, and the embodiments of the invention discussed with reference to FIG. 1 and FIGS. 2A-B can perform operations different than those discussed with reference to the flow diagrams.

FIG. 3A illustrates a flow diagram of exemplary operations that can be performed in a DL network for partial execution of a transaction, in accordance with some embodiments. At operation 302, the client device 106 requests execution of a transaction by a first DL node 102A of a first participant 103A from the participants 103A-N in the DL network 100. The first participant is trusted by the client device 106. For example, the client device 106 is owned/operated by the first participant 103A. In another example, the client device 106 is operated by a customer of the first participant 103A and trust relationship is established between the client device 106 and the DL node 102A of the first participant (e.g., through an authentication mechanism). Because of the trust relationship established between the client device 106 and DL node 102A, the DL node 102A is trusted with the handling of the input data without worrying about data privacy (the client device 106 and DL node 102A are in the same security domain). In some embodiments, the transaction includes zero or more arguments. The transaction may include a set of arguments including a first argument and a second argument. In some embodiments, the transaction may include more than two arguments, e.g., an additional optional third argument. In some embodiments, the request for the transaction includes a call to a smart contract with the arguments of the transaction. For example, the call to the smart contract can include a call for execution of a method from a smart contract with the first argument and a second argument. The smart contract may include one or more subroutines.

The flow of operations moves to operation 304. At operation 304, the client device 106 receives first results of a first execution of the transaction and subroutine information for the transaction. In some embodiments, the execution of the transaction can be a partial execution of the transaction, where the DL node 102A executes the first subroutine but not one or more other subroutines of the transaction. In some embodiments, the execution of the transaction can include execution of all the subroutines of the transaction by the DL node 102A. The partial execution of the transaction may include the execution of one or more subroutines of the transaction that the DL node 102A is authorized to access/execute. For example, the partial execution of the transaction may include execution of the first subroutine with the first argument without execution of the second subroutine. In some embodiments, partial execution of the transaction can be performed as described in further detail with respect to FIG. 3E. The subroutine information includes a first subroutine associated with a first set of participants and a second subroutine associated with a second set of participants. In some embodiments, the first results are obtained following the partial execution of the transaction by DL node 102A.

The flow of operations moves to operation 308. At operation 308, the client device 106 determines whether execution of one or more subroutines of the transaction is needed. Determining whether the execution of subroutines is needed may be performed upon determining that the result received from the DL node 102A are partial results and do not represent the full execution of all subroutines of the transaction. In some embodiments, determining that the execution of subroutines is needed is performed upon receipt of the subroutine information that identifies multiple distinct participants as authorized to execute different subroutines. In some embodiments, the determination that the execution of subroutines is needed can further be performed based on the endorsement rule(s) defined for one or more of the subroutines. In some embodiments, this operation is optional and may not be performed. If it is determined that no additional execution of the transaction is needed (i.e., the transaction has been fully executed), the flow of operations moves to operation 318, at which the client device 106 records the transaction in the DL network 100. Recording the transaction in the DL network 100 includes storing the transaction in the digital ledger of the DL network 100. Alternatively, if it is determined that additional executions of subroutines is needed the flow of operations moves to operation 310.

The flow of operations moves to operation 310. At operation 310, the client device 106 obtains an execution plan for the subroutines of the transaction. In some embodiments, the client device 106 is operative to perform the determination of the execution plan. In some embodiments, the client device 106 is operative to communicate with another node (another electronic device that is communicatively coupled with the client device) that is to determine the execution plan. In this embodiment, the client device 106 is operative to transmit subroutine information (and optionally the first results) to the node and receive the execution plan from the node. The determination of the execution plan is performed at the node.

In some embodiments, determining an execution plan for the subroutines of the transaction includes determining one or more participants and/or DL nodes of participants that can execute the transaction (at least partially) for enabling full execution of the transaction. The participants can be indicated in the subroutine information, where each subroutine is associated with one or more participants that are authorized to execute/access the subroutine. In some embodiments, the determination of the execution plan can further be performed based on external knowledge of the state of the various DL nodes/participants in the DL network. For example, the execution plan may include the first participant for first subroutine and second participant for second subroutine. In some embodiments, the execution plan further identifies for each subroutine the argument(s) that the subroutine needs for execution. For example, the execution plan may identify a first argument for a first subroutine and a second argument for a second subroutine. In some embodiments, the determination of the execution plan can further be performed based on the endorsement rule(s) defined for one or more of the subroutines. For example, an endorsement rule for a first subroutine may include that the subroutine is to be executed/endorsed by at least two participants. In this example, the execution plan includes an indication that the transaction is to be executed by the first participant and an indication that transaction is to be execution by a second participant.

The flow of operations moves to operation 312A. At operation 312A, the client device 106 requests execution of the transaction by a second DL node of a second participant based on the execution plan. For example, upon determining that the second participant is authorized to execute the second subroutine, the client device requests execution of the transaction and includes the second argument for the second subroutine. In some embodiments, the request for execution of the transaction sent to the second DL node does not includes any argument that is not needed by the second subroutine. For example, the request does not include the first argument, which is used for the first subroutine. In some embodiments, the client device 106 transmits to the second DL node only the arguments that the second participant is authorized to access. In other embodiments, the client device 106 may transmit additional arguments in the request, which may or may not be used by the DL node 102B during partial execution of the transaction.

In some embodiments, the transaction may include additional subroutines, e.g., third subroutine. In these embodiments, the flow of operations may further include operation 312B. At operation 312B, the client device 106 requests execution of the transaction by a third DL node of a third participant based on the execution plan. For example, upon determining that the third participant is authorized to execute the third subroutine, the client device 106 requests execution of the transaction and includes the third argument for the third subroutine. In some embodiments, the request for execution of the transaction sent to the third DL node does not include any argument that is not needed by the third subroutine. In some embodiments, the third subroutine may use one or more arguments that are common to one or more other subroutines. For example, the third subroutine may further need the second argument to be executed. In this example, the client device 106 may transmit to the third DL node the request for execution of the transaction including the second argument and the third argument.

In some embodiments, the execution plan indicates that the same subroutine, e.g., second subroutine needs to be executed by more than one participant for the transaction to be considered executed and valid. In these embodiments, operation 312B may include transmitting the transaction with the second argument to another participant, third participant, to execute the second subroutine.

The flow of operations moves to operation 316A. At operation 316A, the client device 106 receives second results of a second execution of the transaction at the second DL node. In some embodiments, the execution of the transaction at the second DL node is a partial execution of the transaction. The partial execution of the transaction may include the execution of one or more subroutines of the transaction that the DL node 102B is authorized to access/execute. For example, the partial execution of the transaction includes execution of the second subroutine with the second argument without execution of the first subroutine. In some embodiments, partial execution of the transaction can be performed as described in further detail with respect to FIG. 3E. In some embodiments, the second results are obtained following the partial execution of the transaction by DL node 102B. In some embodiments, the client device 106 further receives the subroutine information as determined by the DL node 102B following the partial execution of the transaction. In some embodiments, the subroutine information is the same information as the one received from the DL node 102A. In some embodiments, the subroutine information is not received as it is previously received from the DL node 102A.

When the execution plan includes more than one subroutine to be executed, the flow of operations may include operations 316B. At operation 316B, the client device 106 receives third results of a third partial execution of the transaction at the third DL node. In some embodiments, the execution of the transaction at the third DL node is a partial execution of the transaction. The partial execution of the transaction may include the execution of one or more subroutines of the transaction that the DL node 102N is authorized to access/execute. For example, the partial execution of the transaction includes execution of the third subroutine with the third argument without execution of the first subroutine or the second subroutine. Additionally or alternatively, the partial execution of the transaction includes execution of the second subroutine with the second argument without execution of the first subroutine. In some embodiments, partial execution of the transaction can be performed as described in further detail with respect to FIG. 3E. In some embodiments, the third results are obtained following the partial execution of the transaction by DL node 102N. In some embodiments, the client device 106 further receives the subroutine information as determined by the DL node 102N following the partial execution of the transaction. In some embodiments, the subroutine information is the same information as the one received from the DL node 102A or the DL node 102B. In some embodiments, the subroutine information is not received as it is previously received from the DL node 102A.

The flow of operations moves to operation 317. At operation 317, the client device 106 performs validation of the transaction based on bundled results that include the first results and the second results. In some embodiments, performing validation of the transaction based on the bundled results is performed as described with reference to FIG. 3B.

Upon determining that the transaction is validated, the flow of operations moves to operation 318. At operation 318, the client device 106 records the transaction in the DL network 100. In some embodiments, recording the transaction in the DL network 100 includes transmitting the transaction with the bundled results to an orderer node in the DL network 100. The orderer node is operative to include the transaction in a block or other data structure for inclusion in the digital ledger of the DL network 100. In some embodiments, recording the transaction in the DL network 100 may include transmitting the transaction with the bundled results to one or more of the DL nodes (e.g., DL node 102A-N) for performing a consensus algorithm and including the transaction in the digital ledger of the DL network. In some embodiments, recording the transaction may further cause one or more additional DL nodes to validate the transaction as per the operations of FIG. 3G.

FIG. 3B illustrates a flow diagram of exemplary operations that can be performed in a DL network for performing validation of a transaction based on bundled results, in accordance with some embodiments.

At operation 320, the client device 106 combines results obtained from executions of the transaction at multiple DL nodes of different participants to obtain bundled results for the transaction. For example, the client device 106 combines the first and the second results to obtain the bundled results. The client device 106 may further combine the third results with the first and the second results to obtain the bundled results. Additional results obtained from additional executions of the transaction by one or more participants can also be combined without departing from the scope of the embodiments herein. In some embodiments, the client device 106 verifies that the responses received from the different DL nodes are not conflicting (e.g., that the execution results are consistent and/or the subroutine information is consistent) prior to combining the results. For example, if an execution plan identifies two different participants for execution of a subroutine, e.g., the second subroutine and participant 103B and participant 103B, the combination of the results from the execution of the second subroutine from each one of the participants may include determining that the second results and the third results are similar or identical.

The client device 106 requests, at operation 322, validation of the transaction based on the bundled results. In some embodiments, the request for validation of the transaction is transmitted to the DL node 102A that is trusted by the client device 106. The DL node 102A validates the transaction based on the bundled results at operation 222. In some embodiments, the validation of the transaction is performed based on the exemplary operations of FIG. 3G. The client device 106 receives a validation outcome at operation 324. The validation outcome may include an indication that the execution of the transaction is valid. Alternatively, the validation outcome may include an indication that the execution of the transaction is not valid. In this case, the validation outcome may further include the identification of one or more executions that need to be performed for validating the execution of the transaction. When one or more executions are identified as being needed for completing the execution and validation of the transaction, the execution plan may be updated to include the additional executions. For example, the execution plan may be updated to include one or more additional participant(s) that are to execute one or more additional subroutine(s) of the transaction with additional argument(s). The client device 106 is operative to request execution of the additional subroutine(s) from the additional participants.

At operation 326, the client device 106 determines whether the validation outcome is satisfactory. Upon determining that the transaction is not validated, the client device 106 may request additional partial executions of the transaction, at operation 328. Upon determining that the transaction is validated, the flow of operations moves to operation 318.

FIG. 3C illustrates a flow diagram of exemplary operations that can be performed in a DL network for performing validation of a transaction based on bundled results, in accordance with some embodiments. In these embodiments, the client device 106 is operative to validate the transaction based on the bundled results instead of requesting validation from another node in the DL network 100. Operation 320 as described with reference to FIG. 3B is performed. The flow of operations moves to operation 330, at which the client device 106 validates the transaction based on the bundled results to obtain a validation outcome. In some embodiments, the validation of the transaction is performed based on the exemplary operations of FIG. 3G. The validation outcome may include an indication that the execution of the transaction is valid. Alternatively, the validation outcome may include an indication that the execution of the transaction is not valid. In this case, the validation outcome may include the identification of one or more executions that need to be performed for validating the execution of the transaction. The flow of operations moves to operation 326, at which the client device 106 determines whether the validation outcome is satisfactory. Upon determining that the transaction is not validated, the client device 106 may request additional partial executions of the transaction, at operation 328. Upon determining that the transaction is validated, the flow of operations moves to operation 318.

FIG. 3D illustrates a flow diagram of exemplary operations that can be performed for partial execution of a transaction, in accordance with some embodiments. The operations of FIG. 3D can be performed by a DL node of the DL network 100, e.g., DL node 102A. While the embodiments herein are described with respect to DL node 102A, similar operations can be performed by one or more other DL nodes in the DL network. For example, DL node 102B or DL node 102N can perform similar operations.

At operation 332, the DL node 102A receives the request for execution of the transaction. The flow of operations moves to operation 334. At operation 334, The DL node 102A executes the transaction to obtain first results. In some embodiments, the execution of the transaction can be a partial execution of the transaction. In some embodiments, the execution of the transaction can include execution of all the subroutines of the transaction by the DL node 102A. The partial execution of the transaction may include the execution of one or more subroutines of the transaction that the DL node 102A is authorized to access/execute. For example, the partial execution of the transaction may include execution of the first subroutine with the first argument without execution of the second subroutine as the DL node is determined to be authorized to execute the first subroutine but not the second subroutine. Alternatively or additionally, the execution of the first subroutine but not the second subroutine may be due to the DL node 102A being authorized to access and use the first argument but not the second argument. For example, the second argument may be private data that is not accessible to the DL node 102A. While herein DL node 102A is described as being authorized and/or having access to a subroutine or data, one of ordinary skill in the art would understand that this authorization can be given to the owner/operator of the DL node 102A, the participant 103A. Therefore, a DL node 102A may be authorized to access data or subroutines as a result of the participant 103A having that authorization. In some embodiments, first results are obtained from the partial execution of the transaction by DL node 102A (e.g., by execution of the first subroutine with the first argument). In some embodiments, partial execution of the transaction can be performed as described in further detail with respect to FIG. 3E.

The flow of operations moves to operation 336. At operation 336, the DL node 102A determines subroutine information for the transaction. The subroutine information includes one or more subroutines of a smart contract that need to be executed for fully executing the transaction. In some embodiments, the subroutine information includes a first subroutine associated with a first set of participants and a second subroutine associated with a second set of participants.

The flow of operations moves to operation 338. At operation 338, the DL node 102A transmits the first results and the subroutine information to the client device 106. In some embodiments, the subroutine information and first results are signed by the DL node 102A.

FIG. 3E illustrates a flow diagram of exemplary operations that can be performed for partial execution of a transaction and determination of subroutine information for the transaction, in accordance with some embodiments.

At operation 340, the smart contract is retrieved. For example, the smart contract can be retrieved from the digital ledger of the DL network. At operation 342, the subroutine descriptions data structure is initialized. The subroutine description data structure contains the information about each of the subroutine of the smart contract. For example, a subroutine description includes one or a combination of the identifier, the set of recipients, the endorsement rule, and the subset of arguments of the subroutine. The subroutine description data structure is used to store the subroutine information for a transaction.

At operation 344, the subroutine results data structure is initialized. The subroutine result data structure will contain the result of the execution of each subroutine. For each subroutine, the participants associated with the subroutine are determined, at operation 346. The participants associated with the subroutine may be included as metadata for the subroutine within the code of the subroutine. In some embodiments, the participants associated with the subroutine may be determined dynamically at runtime upon execution of one or more subroutines. In some embodiments, the DL node further determines the endorsement rules for the subroutine, and the arguments needed for executing the subroutine. This determination may be performed by accessing data from the digital ledger. The flow moves to operation 348, at which a determination of whether the local DL node, e.g., DL node 102A, is authorized to execute the subroutine is performed. The determination of whether the local DL node is authorized to execute the subroutine may include determining that the set of participants associated with the subroutine is empty or alternatively that the first participant (that owns the DL node 102A) is included in the set of participants associated with the subroutine. Upon determining that the local DL node is authorized to execute the subroutine, the flow of operations moves to operation 350. Alternatively, when it is determined that the local DL node is not authorized to execute the subroutine, the flow of operations moves to operation 356.

At operation 350, the DL node executes the subroutine. In some embodiments, the subroutine is executed with a first argument. While execution of a subroutine is described with respect to an argument, here the first argument, in some embodiments, less or more arguments can be used. For example, a subroutine can be executed without any arguments. Alternatively, a subroutine can be executed with more than one argument. Two subroutines may share a subset or all of the arguments.

In some embodiments, the flow of operations moves to operation 352, at which the DL node determines whether the execution of the subroutine is successful. For example, the DL node may determine whether some or all of the data needed for execution of the subroutine is accessible. Upon determining that some data is not accessible, the flow of operations moves to operation 354, at which an error message is output and the execution of the transaction is aborted. Upon determining that the execution of the subroutine is successful, the flow of operations moves to operation 356. At operation 356, the description of the subroutine is added to the subroutine description data structure.

At operation 358, the result of execution of the subroutine is added to the subroutine result data structure. The DL node determines whether there are more subroutines to execute for the transaction, at operation 360. Upon determining that at least one subroutine has not been executed, the flow of operations moves to operation 346, and the execution of the next subroutine is performed. Alternatively, if all subroutines have been executed, the flow of operations moves to operation 362, at which the DL node outputs the result of execution of the subroutines and the subroutine information. The subroutine information includes the descriptions of the subroutines included in the smart contract of the transaction. The subroutine information is retrieved from the subroutine description data structure.

FIG. 3F illustrates a flow diagram of exemplary operations that can be performed for validation of a transaction and validation of subroutines of the transaction, in accordance with some embodiments.

At operation 370, the DL node 102A receives a request to validate the transaction based on bundled results. The bundled results includes the first results from the partial execution of the first subroutine by the DL node 102A and one or more additional results from partial executions of one or more subroutines by other DL nodes (that are owned by other participants). For example, the bundled results includes second results from the partial execution of a second subroutine of the transaction by another DL node, e.g., DL node 102B.

The flow of operations moves to operation 372, at which the DL node 102A validates the transaction based on the bundled results. The validation of the transaction includes a validation at the transaction level and validation of subroutines of the transaction. In some embodiments, the validation of the transaction can be performed based on operations described with respect to FIG. 3G.

The flow of operations moves to operation 374, at which the DL node 102A transmits a validation outcome to the client device 106. In some embodiments, the validation outcome indicates that the transaction is validated. In other embodiments, the validation outcome indicates that the transaction is not valid. In some embodiments, the validation outcome may include an identification of additional partial executions (e.g., an identification of participants that need to execute one or more subroutine) that need to be performed for validating execution of the transaction.

FIG. 3G illustrates a flow diagram of exemplary operations that can be performed for validation of a transaction based on bundled results and validation of subroutines of the transaction, in accordance with some embodiments. The operations of FIG. 3G can be performed by DL node 102A upon receipt of a request to validate the transaction based on the bundled results. In some embodiments, the operations of FIG. 3G can further be performed by one or more DL nodes of the DL network 100 during and/or after a consensus mechanism for recording the transaction in the digital ledger of the DL network.

The validation of the transaction based on the bundled results includes operation 382, at which the DL node 102A validates the transaction at the smart contract level. In some embodiments, validating the transaction at the smart contract level includes fetching the smart contract endorsement policy that specifies, at the smart contract level, which endorsements are needed for the execution of the smart contract to be valid. This information is typically stored in the digital ledger. The validation of the transaction at the smart contract level further includes for each one of the endorsements, verify that they are identical. If not, end the execution with an error. Non identical endorsement means that the smart contract is nondeterministic or that different DL nodes have different versions of the digital ledger. The validation of the transaction at the smart contract further includes verifying that the signatures of the results are valid (i.e., that the DL nodes that partially executed the transaction are authenticated). If not, end the execution with an error. The determination that a signature of a DL node is not valid is an indication that the DL node is misconfigured or actively trying to deceive other DL nodes of the DL network 100. The DL node 102A further determines that the smart contract endorsement policy is satisfied. If one or more endorsements are missing (not satisfied by the results included in the bundle), the missing endorsements may be included to be transmitted to the client device 106.

The validation of the transaction further includes a validation at the subroutine level. Thus, in contrast to existing transaction validation mechanisms which may include validation at a smart contract level, the embodiments described here further include validation of the transaction at the subroutine level for the subroutines of the transaction.

The validation is performed for each subroutine from the multiple subroutines of the transaction. At operation 390, the DL node determines whether there are still some subroutines that have not been validated, upon determining that there is at least one subroutine that is not yet validated, the flow of operations moves to operation 392. At operation 392, fetches the endorsement rule associated with that subroutine (from the subroutine information). For example, the endorsement rule of a subroutine may identify two participants that need to endorse (execute) the subroutine. The flow of operations moves to operation 394, at which the DL node verifies that the endorsement rule for the subroutine is satisfied. Verifying that the endorsement rule is satisfied includes determining that the participants identified in the endorsement rule have executed the subroutine, that the participants are authenticated, and that the results of execution of the subroutine by the DL nodes of these participants is consistent with one another (e.g., that the results are identical). Upon verifying that the endorsement rule for the subroutine is satisfied, the flow of operations moves to operation 390, for repeating the operations for a next subroutine. Alternatively, upon verifying that the endorsement rule for the subroutine is not satisfied, the flow of operations moves to operation 396. At operation 396, the subroutine is added to a list of subroutine for which endorsement is missing. This operation is optional and can be skipped in some embodiments.

When it is determined that all subroutines of a transaction are validated, or that validation of subroutines of the transaction has been evaluated for all the subroutines, the validation of the transaction at the subroutine level is completed. The outcome of this validation may include that the subroutines are all validated. Alternatively, the outcome of this validation may include a list of validated subroutines and a list of subroutines for which endorsement is missing. In some embodiments, the DL node 102A may output the list of participants that need to endorse/execute the transaction for validating this transaction. Alternatively, no list is provided by the DL node 102A. When the transaction is validated at both the smart contract level and the subroutines level, the DL node 102A transmits the validation outcome to a network device. For example, the network device can be the client device 106 or another DL node in the DL network.

Architecture:

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the disclosure may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video, etc.). In the embodiments described above the components of the DL network 100 can be implemented on one or more network devices coupled through a physical network. For example, each of the DL nodes 102A-N can be implemented on one ND or distributed over multiple NDs.

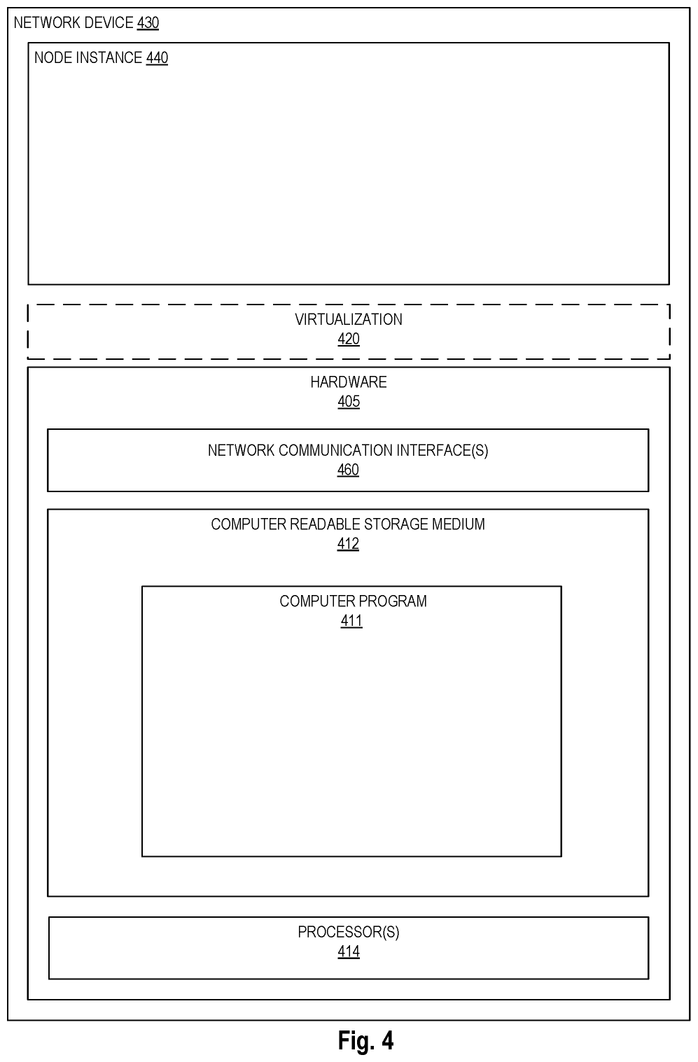

FIG. 4 illustrates a block diagram for a ND that can be used for implementing one or more of the DL nodes described herein, in accordance with some embodiments. According to one embodiment, the ND is an electronic device which includes hardware 405. Hardware 405 includes one or more processors 414, network communication interfaces 460 coupled with a computer readable storage medium 412. The computer readable storage medium 412 may include a computer program 411.

While one embodiment does not implement virtualization, alternative embodiments may use different forms of virtualization—represented by a virtualization layer 420. In these embodiments, the instance 440 and the hardware that executes it form a virtual server which is a software instance of the modules stored on the computer readable storage medium 412.

The computer program 411 includes instructions which when executed by the hardware 405 causes the instance 440 to perform the operations described with reference to FIGS. 1-3F. In this embodiment, the DLT node 102A is implemented on a single network device.

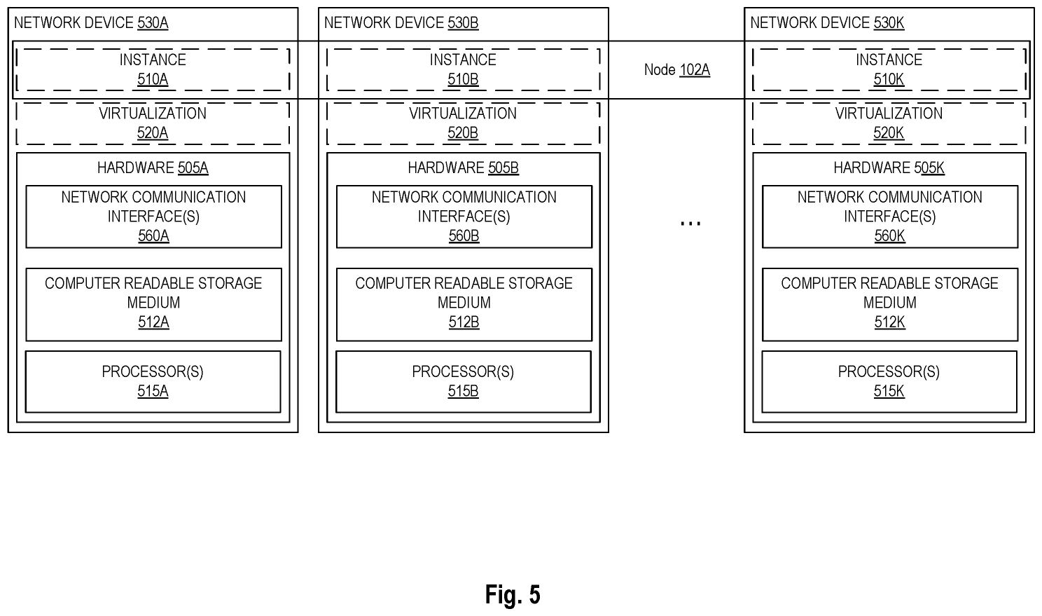

FIG. 5 illustrates an exemplary embodiment in which a node is implemented on multiple network devices. In the illustrated example, the DLT node 102A is distributed over multiple network devices 530A-530K, where each network device has a similar architecture as network device 430. The multiple network devices 530A-530K are coupled through one or more links and can be located in a same geographical location or remote from one another. The operations described with reference to the embodiments of FIGS. 1-3F can be distributed over the multiple network devices, such as each network device is operative to perform a subset of the operations described herein.

While the flow diagrams in the figures show a particular order of operations performed by certain embodiments of the disclosure, it should be understood that such order is exemplary (e.g., alternative embodiments may perform the operations in a different order, combine certain operations, overlap certain operations, etc.).

While the disclosure has been described in terms of several embodiments, those skilled in the art will recognize that the disclosure is not limited to the embodiments described, can be practiced with modification and alteration within the spirit and scope of the appended claims. The description is thus to be regarded as illustrative instead of limiting.

1. A method in a client device of a distributed ledger (DL) network, the method comprising:
requesting execution of a transaction by a first DL node of a first participant from a plurality of participants in the DL network, wherein the first participant is trusted;
receiving first results of a first execution of the transaction and subroutine information for the transaction, wherein the subroutine information includes a first subroutine associated with a first set of participants and a second subroutine associated with a second set of participants;
obtaining an execution plan for executing the first subroutine and the second subroutine;
based on the execution plan, requesting execution of the transaction by a second DL node of a second participant from the second set of participants;
receiving second results of a second execution of the transaction at the second DL node; and
performing validation of the transaction based on bundled results that include the first results and the second results.

2. The method of claim 1 further comprising:
prior to determining the execution plan, determining whether partial execution of the second subroutine is needed; and
wherein the obtaining the execution plan is performed in response to determining that partial execution of the second subroutine is needed.

3. The method of claim 1, wherein the performing validation of the transaction includes:
combining the first results and the second results into bundled results;
requesting validation of the transaction based on the bundled results;
receiving an outcome of the validation of the transaction; and
responsive to determining that the outcome indicates that the transaction is validated, recording the transaction in the DL network.

4. The method of claim 1, wherein the performing validation of the transaction includes:
combining the first results and the second results into bundled results;
validating the transaction based on the bundled results to obtain a validation outcome; and
responsive to determining that the outcome indicates that the transaction is validated, recording the transaction in the DL network.

5. (canceled)

6. The method of claim 1, wherein the subroutine information further includes a first endorsement rule for the first subroutine and a second endorsement rule for the second subroutine.

7. The method of claim 1, wherein the obtaining the execution plan for executing the first subroutine and the second subroutine includes:
determining that the first DL node of the first participant is to execute the first subroutine with a first argument; and
determining that the second DL node of the second participant is to execute the second subroutine with a second argument.

8. The method of claim 1, wherein the obtaining the execution plan for executing the first subroutine and the second subroutine is performed based on the subroutine information for the transaction.

9-11. (canceled)

12. A client device in a distributed ledger (DL) network, the client device comprising:
one or more processors; and
a computer readable storage medium storing instructions which, when executed by the one or more processors cause the client device to perform operations including to:
request execution of a transaction by a first DL node of a first participant from a plurality of participants in the DL network, wherein the first participant is trusted;
receive first results of a first execution of the transaction and subroutine information for the transaction, wherein the subroutine information includes a first subroutine associated with a first set of participants and a second subroutine associated with a second set of participants;
obtain an execution plan for executing the first subroutine and the second subroutine;
based on the execution plan, requesting request execution of the transaction by a second DL node of a second participant from the second set of participants;
receive second results of a second execution of the transaction at the second DL node; and
perform validation of the transaction based on bundled results that include the first results and the second results.

13. The client device of claim 12 further comprising:
prior to determining the execution plan, determine whether partial execution of the second subroutine is needed; and
wherein to obtain the execution plan is performed in response to determining that partial execution of the second subroutine is needed.

14. The client device of claim 12, wherein to perform validation of the transaction includes operations to:
combine the first results and the second results into bundled results;
request validation of the transaction based on the bundled results;
receive an outcome of the validation of the transaction; and
responsive to determining that the outcome indicates that the transaction is validated, record the transaction in the DL network.

15. The client device of claim 12, wherein to perform validation of the transaction includes operations to:
combine the first results and the second results into bundled results;
validate the transaction based on the bundled results to obtain a validation outcome; and
responsive to determining that the outcome indicates that the transaction is validated, record the transaction in the DL network.

16. (canceled)

17. The client device of claim 12, wherein the subroutine information further includes a first endorsement rule for the first subroutine and a second endorsement rule for the second subroutine.

18. The client device of claim 12, wherein to obtain the execution plan for executing the first subroutine and the second subroutine includes operations to:
determine that the first DL node of the first participant is to execute the first subroutine with a first argument; and
determine that the second DL node of the second participant is to execute the second subroutine with a second argument.

19. The client device of claim 12, wherein to obtain the execution plan for executing the first subroutine and the second subroutine is performed based on the subroutine information for the transaction.

20. (canceled)

21. A method in a distributed ledger node of a DL network comprising:
receiving a request to execute a transaction that includes a first subroutine and a second subroutine;
executing the first subroutine to obtain first results without executing the second subroutine;
determining subroutine information for the transaction; and
transmitting the first results and the subroutine information in response to the request to execute the transaction.

22. The method of claim 21 further comprising:
receiving a request to validate the transaction based on bundled results, wherein the bundled results include the first results and second results obtained from execution of the second subroutine at another DL node that is different from the DL node;
validating the transaction based on the bundled results; and
transmitting a validation outcome in response to the request to validate the transaction.

23. The method of claim 22, wherein the validating the transaction based on the bundled results includes:
validating the transaction at a smart contract level; and
validating the transaction at a subroutine level for a set of subroutines of the transaction.

24-26. (canceled)

27. A distributed ledger (DL) node in a DL network, the DL node comprising:
one or more processors; and
a computer readable storage medium storing instructions which, when executed by the one or more processors cause the DL node to perform operations to:
receive a request to execute a transaction that includes a first subroutine and a second subroutine;
execute the first subroutine to obtain first results without executing the second subroutine;
determine subroutine information for the transaction; and
transmit the first results and the subroutine information in response to the request to execute the transaction.

28. The DL node of claim 27, wherein the operations further to:
receive a request to validate the transaction based on bundled results, wherein the bundled results include the first results and second results obtained from execution of the second subroutine at another DL node that is different from the DL node;
validate the transaction based on the bundled results; and
transmit a validation outcome in response to the request to validate the transaction.

29. The DL node of claim 28, wherein to validate the transaction based on the bundled results includes operations to:
validate the transaction at a smart contract level; and
validate the transaction at a subroutine level for a set of subroutines of the transaction.

30. (canceled)
